(19) United States
(12) Patent Application Publication
(10) Pub. No.: US 2026/0038397 A1
(43) Pub. Date: Feb. 5, 2026

(54) 3-D PRINTED PORTRAIT

(71) Applicant: Feel 3D Incorporated, Augusta, GA (US)

(72) Inventors: Jack XHEMALI, Alpharetta, GA (US); Sinjae HYUN, Macon, GA (US); Scott SCHULTZ, Macon, GA (US)

(21) Appl. No.: 19/285,971

(22) Filed: Jul. 30, 2025

Related U.S. Application Data
(60) Provisional application No. 63/677,302, filed on Jul. 30, 2024.

(51) Int. Cl. G09F 27/00; B29C 64/386; B29L 31/34; B33Y 10/00; B33Y 50/00; B33Y 80/00; G06F 3/16

(52) U.S. Cl. CPC G09F 27/005; B29C 64/386; B33Y 10/00; B33Y 50/00; B33Y 80/00; G06F 3/167; B29L 2031/3475

(57) ABSTRACT

This invention relates to 3-dimensional portraits. In various aspects, the articles of manufacture comprise a 3-D printed face, an input sensor and a means for sound generation. In various aspects, the articles of manufacture comprise a 3-D cast face, an input sensor and a means for sound generation. Also disclosed are methods of manufacturing the disclosed 3-dimensional portraits. This abstract is intended as a scanning tool for purposes of searching in the particular art and is not intended to be limiting of the present invention.

### CROSS-REFERENCE TO RELATED APPLICATIONS

This application claims the benefit of U.S. Provisional Patent Application No. 63/677,302, filed Jul. 30, 2024, which is incorporated by reference herein in its entirety.

### BACKGROUND

Generally, there is a need for 3-D printed portraits for people with visual impairments that identify the subject with an audible identity indicator.

### SUMMARY

In accordance with the purpose(s) of the invention, as embodied and broadly described herein, the invention, in one aspect, relates to an article comprising (i) a 3-D printed face attached to a panel, wherein the 3-D printed face is 3-D printed using a software-generated rendition of a face of a subject; (ii) an input sensor; (iii) a means for sound generation; wherein the means for sound generation is communicatively coupled with the input sensor and wherein the means for sound generation is configured to play an audible identity indicator when the input sensor is activated.

In another aspect, the invention relates to an article comprising (i) a 3-D cast face attached to a panel, wherein the cast face is cast from a 3-D printed mold that was generated from a software-generated rendition of a face of a subject, wherein the software-generated rendition of the face comprises from a top of the head to underneath a chin and from a first ear to a second ear and encompasses at least one of a forehead, eyes, nose and mouth; (ii) an input sensor; (iii) a means for sound generation; wherein the means for sound generation is communicatively coupled with the input sensor and is configured to play an audible identity indicator when the input sensor is activated.

Also disclosed herein are methods of making 3-D portraits of a subject comprising: (i) printing a software-generated rendition of a face of the subject using additive manufacturing to make a 3-D printed face, wherein the software-generated rendition of the face is created by a) scanning the face of the subject with a 3-D scanner or b) by a computer program generating a 3-D model using a series of 2D images, and wherein the software rendition of the face comprises from a top of a head to underneath a chin and from a first ear to a second ear and encompasses at least one of a forehead, an eye, a nose or a mouth; (ii) attaching the 3-D printed face to a panel; (iii) attaching an input sensor to the panel next to or within the 3-D printed face; and (iv) attaching a means for sound generation to the input sensor, wherein the means for sound generation is communicatively coupled with the input sensor, and wherein the means for sound generation is configured to play an audible identity indicator when the input sensor is activated.

Also disclosed herein are methods of making 3-dimensional portraits comprising (i) printing a software-generated rendition of a face of the subject using additive manufacturing to make a 3-D printed face, wherein the software-generated rendition of the face is created by a) scanning the face of the subject with a 3-D scanner or b) by a computer program generating a 3-D model using a series of 2D images, and wherein the software rendition of the face comprises from a top of a head to underneath a chin and from a first ear to a second ear and encompasses at least one of a forehead, an eye, a nose or a mouth; (ii) making a silicon mold with the 3-D printed face; (iii) using the silicon mold to cast a 3-D cast face; (iv) attaching the 3-D cast face to a wooden panel; (v) attaching an input sensor to the panel next to or within the 3-D cast face; and (vi) attaching a means for sound generation to the input sensor, wherein the means for sound generation is communicatively coupled with the input sensor, and wherein the means for sound generation is configured to play an audible identity indicator when the input sensor is activated.

Also disclosed herein are methods of making 3-dimensional portraits comprising: (i) scanning a head with a scanner to create a software-generated rendition of the head or using a computer program to generate a 3-D model using a series of 2D images; (ii) using software to limit the software-generated rendition of the head to a software-generated rendition of a face, wherein the software-generated rendition of the face comprises from a top of the head to underneath a chin and from a first ear to a second ear and encompasses at least one of a forehead, eyes, nose and mouth; (iii) printing the software-generated rendition of the face using additive manufacturing to make a 3-D printed face; (iv) attaching the 3-D printed face to a wooden panel; (v) attaching an input sensor to the panel next to or within the 3-D printed face; and (vi) attaching a means for sound generation to the input sensor, wherein the means for sound generation is communicatively coupled with the input sensor, and wherein the means for sound generation is configured to play an audible identity indicator when the input sensor is activated.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### EMBODIMENTS

Embodiment 1. An article comprising: (i) a 3-D printed face attached to a panel, wherein the 3-D printed face is 3-D printed using a software-generated rendition of a face of a subject; (ii) an input sensor; (iii) a means for sound generation; wherein the means for sound generation is communicatively coupled with the input sensor and wherein the means for sound generation is configured to play an audible identity indicator when the input sensor is activated.

Embodiment 2. The article of embodiment 1, wherein the 3-D printed face is attached to the panel with an adhesive or a mechanical fastener.

Embodiment 3. The article of any one of embodiments 1-2, wherein the input sensor comprises text in braille.

Embodiment 4. The article of any one of embodiments 1-3, wherein the input sensor is a pressure-sensitive sensor, a touch sensor, a capacitative touch sensor or a push-button switch.

Embodiment 5. The article of any one of embodiments 1-4, wherein the input sensor is under or integrated with the 3-D printed face such that when the 3-D printed face is touched, the input sensor is activated.

Embodiment 6. The article of any one of embodiments 1-4, wherein the input sensor is below, above, to the right of, to the left of, or within the 3-D printed face.

Embodiment 7. The article of any one of embodiments 1-6, wherein the means for sound generation comprises a solid state player.

Embodiment 8. The article of embodiment 7, wherein the means for sound generation further comprises a speaker or a Bluetooth transmitter.

Embodiment 9. The article of any one of embodiments 1-8, wherein the audible identity indicator identifies a name of the subject.

Embodiment 10. The article of any one of embodiments 1-9, wherein the article comprises a second 3-D printed face and wherein the second 3-D printed face is a software-generated rendition of a face of a second subject.

Embodiment 11. The article of embodiment 10, further comprising a second input sensor; wherein the second input sensor is communicatively coupled with the means for sound generation and wherein the means for sound generation is configured to play a second audible identity indicator when the second input sensor is activated.

Embodiment 12. An article comprising: (i) a 3-D cast face attached to a panel, wherein the cast face is cast from a mold that was generated from a software-generated rendition of a face of a subject, wherein the software-generated rendition of the face comprises from a top of the head to underneath a chin and from a first ear to a second ear and encompasses at least one of a forehead, eyes, nose and mouth; (ii) an input sensor; (iii) a means for sound generation; wherein the means for sound generation is communicatively coupled with the input sensor and is configured to play an audible identity indicator when the input sensor is activated.

Embodiment 13. The article of embodiment 12, wherein the 3-D cast face is attached to the panel with an adhesive or a mechanical fastener.

Embodiment 14. The article of embodiment 12 or embodiment 13, wherein the input sensor comprises text in braille.

Embodiment 15. The article of any one of embodiments 12-14, wherein the input sensor is a pressure sensitive sensor, a touch sensor, a capacitative touch sensor or a push-button switch.

Embodiment 16. The article of any one of embodiments 12-15, wherein the input sensor is under or integrated with the 3-D cast face such that when the 3-D cast face is touched, the input sensor is activated.

Embodiment 17. The article of any one of embodiments 12-15, wherein the input sensor is below, above, to the right of, to the left of, or within the 3-D cast face.

Embodiment 18. The article of any one of embodiments 12-17, wherein the article comprises a second 3-D cast face attached to the panel, wherein the second 3-D cast face is manufactured from a second silicon mold made with a second 3-D printed face using a second software-generated rendition of a face of a second subject.

Embodiment 19. The article of embodiment 18, further comprising a second input sensor; wherein the second input sensor is communicatively coupled with the means for sound generation and wherein the means for sound generation is configured to play a second audible identity indicator when the second input sensor is activated.

Embodiment 20. The article of any one of embodiments 1-19, wherein the audible identity indicator identifies a name of the subject.

Embodiment 21. A method of making a 3-dimensional portrait of a subject comprising: (i) printing a software-generated rendition of a face of the subject using additive manufacturing to make a 3-D printed face, wherein the software-generated rendition of the face is created by a) scanning the face of the subject with a 3-D scanner or b) by a computer program generating a 3-D model using a series of 2D images, and wherein the software rendition of the face comprises from a top of a head to underneath a chin and from a first ear to a second ear and encompasses at least one of a forehead, an eye, a nose or a mouth; (ii) attaching the 3-D printed face to a panel; (iii) attaching an input sensor to the panel next to or within the 3-D printed face; and (iv) attaching a means for sound generation to the input sensor, wherein the means for sound generation is communicatively coupled with the input sensor, and wherein the means for sound generation is configured to play an audible identity indicator when the input sensor is activated.

Embodiment 22. The method of embodiment 21, wherein the step of attaching the 3-D printed face to the panel comprises using an adhesive or a mechanical fastener.

Embodiment 23. The method of embodiment 21 or embodiment 22, wherein the input sensor comprises text in braille.

Embodiment 24. The method of any one of embodiments 21-23, wherein the input sensor is a pressure sensitive sensor, a touch sensor, a capacitative touch sensor or a push-button switch.

Embodiment 25. The method of any one of embodiments 21-24, wherein the input sensor is under or integrated with the 3-D printed face such that when the 3-D printed face is touched, the input sensor is activated.

Embodiment 26. The method of any one of embodiments 21-24, wherein the input sensor is below, above, to the right of, to the left of, or within the 3-D printed face.

Embodiment 27. The method of any one of embodiments 21-26, wherein the audible identity indicator identifies a name of the subject.

Embodiment 28. The method of any one of embodiments 21-27, wherein said method further comprises (i) printing a software-generated rendition of a face of a second subject using additive manufacturing to make a second 3-D printed face; (ii) attaching the second 3-D printed face to the panel; (iii) attaching a second input sensor to the panel next to or within the second 3-D printed face; wherein the means for sound generation is communicatively coupled with the second input sensor, and wherein the means for sound generation is configured to play a second audible identity indicator when the second input sensor is activated.

Embodiment 29. A method of making a 3-dimensional portrait comprising: (i) printing a software-generated rendition of a face of the subject using additive manufacturing to make a 3-D printed face, wherein the software-generated rendition of the face is created by a) scanning the face of the subject with a 3-D scanner or b) by a computer program generating a 3-D model using a series of 2D images, and wherein the software rendition of the face comprises from a top of a head to underneath a chin and from a first ear to a second ear and encompasses at least one of a forehead, an eye, a nose or a mouth; (ii) making a silicon mold with the 3-D printed face; (iii) using the silicon mold to cast a 3-D cast face; (iv) attaching the 3-D cast face to a wooden panel; (v) attaching an input sensor to the panel next to or within the 3-D cast face; and (vi) attaching a means for sound generation to the input sensor, wherein the means for sound generation is communicatively coupled with the input sensor, and wherein the means for sound generation is configured to play an audible identity indicator when the input sensor is activated.

Embodiment 30. The method of embodiment 29, wherein the step of attaching the 3-D cast face to the panel comprises the use of an adhesive or mechanical fastener.

Embodiment 31. The method of embodiment 29 or embodiment 30, wherein the input sensor comprises text in braille.

Embodiment 32. The method of any one of embodiments 29-31, wherein the input sensor is a pressure sensitive sensor, a touch sensor, a capacitative touch sensor or a push-button switch.

Embodiment 33. The method of any one of embodiments 29-32, wherein the input sensor is under or integrated with the 3-D cast face such that when the 3-D printed face is touched, the input sensor is activated.

Embodiment 34. The method of any one of embodiments 29-32, wherein the input sensor is below, above, to the right of, to the left of, or within the 3-D cast face.

Embodiment 35. The method of any one of embodiments 29-34, wherein the audible identity indicator identifies a name of the subject.

Embodiment 36. The method of any one of embodiments 29-35, wherein said method further comprises (i) manufacturing a second 3-D cast face of a second subject; (ii) attaching the second 3-D cast face to the panel; (iii) attaching a second input sensor to the panel next to or within the second 3-D cast face; wherein the means for sound generation is communicatively coupled with the second input sensor, and wherein the means for sound generation is configured to play a second audible identity indicator when the second input sensor is activated.

Embodiment 37. A method of making a 3-dimensional portrait comprising: (i) scanning a head with a scanner to create a software-generated rendition of the head or using a computer program to generate a 3-D model using a series of 2D images; (ii) using software to limit the software-generated rendition of the head to a software-generated rendition of a face, wherein the software-generated rendition of the face comprises from a top of the head to underneath a chin and from a first ear to a second ear and encompasses at least one of a forehead, eyes, nose and mouth; (iii) printing the software-generated rendition of the face using additive manufacturing to make a 3-D printed face; (iv) attaching the 3-D printed face to a wooden panel; (v) attaching an input sensor to the panel next to or within the 3-D printed face; and (vi) attaching a means for sound generation to the input sensor, wherein the means for sound generation is communicatively coupled with the input sensor, and wherein the means for sound generation is configured to play an audible identity indicator when the input sensor is activated.

Embodiment 38. The method of embodiment 37, wherein the step of attaching the 3-D printed face to the panel comprises the use of an adhesive or a mechanical fastener.

Embodiment 39. The method of embodiment 37 or embodiment 38, wherein the input sensor comprises text in braille.

Embodiment 40. The method of any one of embodiments 37-39, wherein the input sensor is a pressure sensitive sensor, a touch sensor, a capacitative touch sensor or a push-button switch.

Embodiment 41. The method of any one of embodiments 37-40, wherein the input sensor is under or integrated with the 3-D printed face such that when the 3-D printed face is touched, the input sensor is activated.

Embodiment 42. The method of any one of embodiments 37-40, wherein the input sensor is below, above, to the right of, to the left of, or within the 3-D printed face.

Embodiment 43. The method of any one of embodiments 37-42, wherein the audible identity indicator identifies a name of the subject.

Embodiment 44. The method of any one of embodiments 37-43, wherein said method further comprises (i) 3-D printing a second software-generated rendition of a face of a second subject using additive manufacturing to make a second 3-D printed face; (ii) attaching the second 3-D printed face to the panel; (iii) attaching a second input sensor to the panel next to or within the second 3-D printed face; wherein the means for sound generation is communicatively coupled with the second input sensor, and wherein the means for sound generation is configured to play a second audible identity indicator when the second input sensor is activated.

### BRIEF DESCRIPTION OF THE FIGURES

The accompanying drawings, which are incorporated in and constitute a part of this specification, illustrate several aspects of the invention and together with the description, serve to explain the principles of the invention.

FIG. 1 shows a representative view of an embodiment of the articles described herein.

FIG. 2 shows a representative view of an embodiment of the articles described herein.

FIGS. 3A and 3B show a representative view of the front (A) and back (B) of an embodiment of the articles described herein.

FIG. 4 shows a schematic diagram of the mechanism for playing an audible identity indicator.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description, examples, drawings, and claims, and their previous and following descriptions. However, before the present devices and/or methods are disclosed and described, it is to be understood that this invention is not limited to the specific devices and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

### A. Definitions

As used throughout, the singular forms “a,” “an,” and “the” include plural referents unless the context clearly dictates otherwise. Thus, for example, reference to “a fastener” can include two or more such fasteners unless the context indicates otherwise.

As used in the specification and in the claims, the term “comprising” can include the aspects “consisting of” and “consisting essentially of.”

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and, in an alternative aspect, can also include any combination of members of that list.

The terms “first,” “second,” “first part,” “second part,” and the like, as used herein, do not denote any order, quantity, or importance, and are used to distinguish one element from another, unless specifically stated otherwise.

### B. Articles

In one aspect, disclosed are articles comprising: (a) a 3-D printed face attached to a panel, wherein the 3-D printed face is 3-D printed using a software-generated rendition of a face of a subject

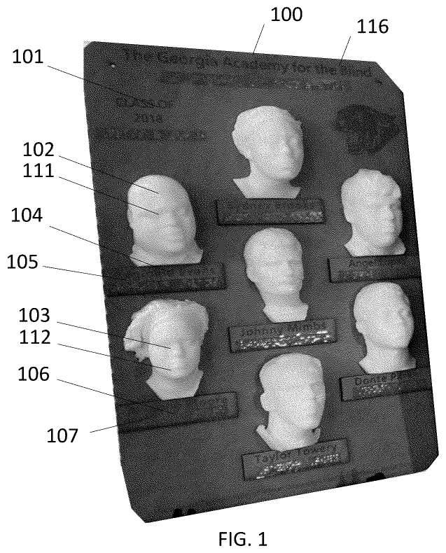

Referring to FIG. 1, for example, article 100 comprises a panel 101, a first 3D-printed face 102 and a second 3-D printed face 103. First 3D-printed face 102 comprises first input sensor 111 embedded within it. Underneath first 3D-printed face 102 is area 104. Area 104 comprises a first set of braille letters 105 for identification of the subject of the first 3D-printed face 102. Second 3D-printed face 103 comprises second input sensor 112 embedded within it. Underneath second 3D-printed face 103 is area 106. Area 106 comprises a second set of braille letters 107 for identification of the subject of the second 3D-printed face 103. Embedded within article 100 is means for sound generation 116.

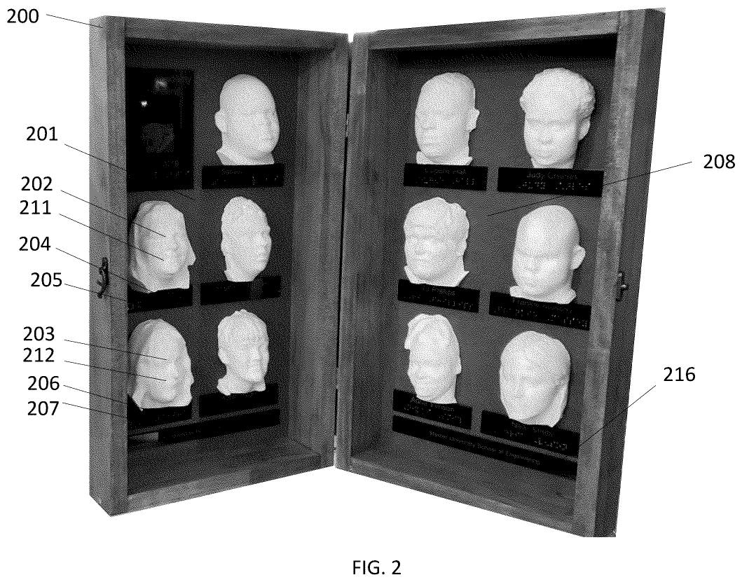

Referring to FIG. 2, for example, article 200 comprises a panel 201, a 3D-printed face 202 and a second 3-D printed face 203. First 3D-printed face 202 comprises first input sensor 211 embedded within it. Underneath first 3D-printed face 202 is an area 204. Area 204 comprises a first set of braille letters 205 for identification of the subject of the first 3D-printed face 202. Second 3D-printed face 203 comprises second input sensor 212 embedded within it. Underneath second 3D-printed face 203 is area 206. Area 206 comprises a second set of braille letters 207 for identification of the subject of the second 3D-printed face 203. Article 200 also comprises a second panel 208. Embedded within article 200 is means for sound generation 216.

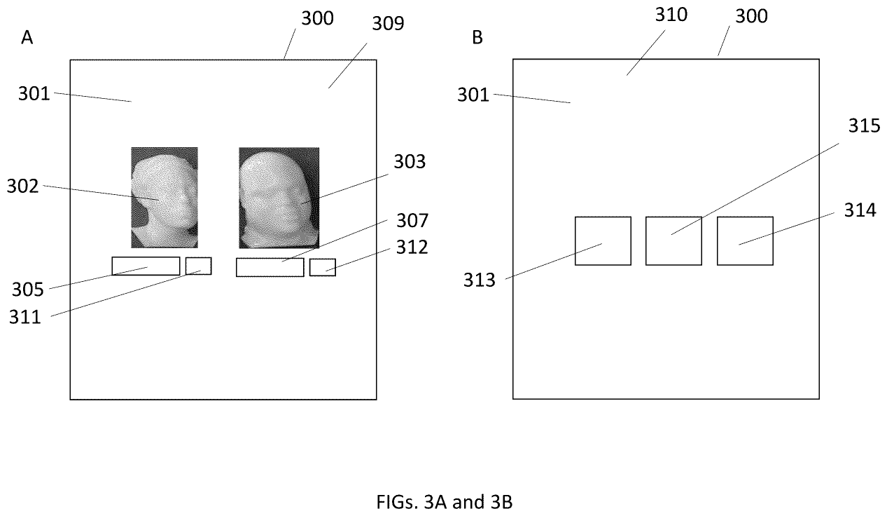

Referring to FIG. 3A, for example, article 300 comprises a panel 301 having a front side 309 comprising a first 3D printed face 302 and a second 3D printed face 303. Underneath first 3D printed face 302 is a first set of braille letters 305 for identification of the subject of the first 3D printed face 302. To the right of the first set of braille letters 305 is a first input sensor 311. Underneath second 3D printed face 303 is a second set of braille letters 307 for identification of the subject of the second 3D-printed face 303. To the right of the second set of braille letters 307 is a second input sensor 312.

Referring to FIG. 3B, for example, article 300 comprises a panel 301 having a back side 310 comprising power source 313, speaker 314 and microchip 315.

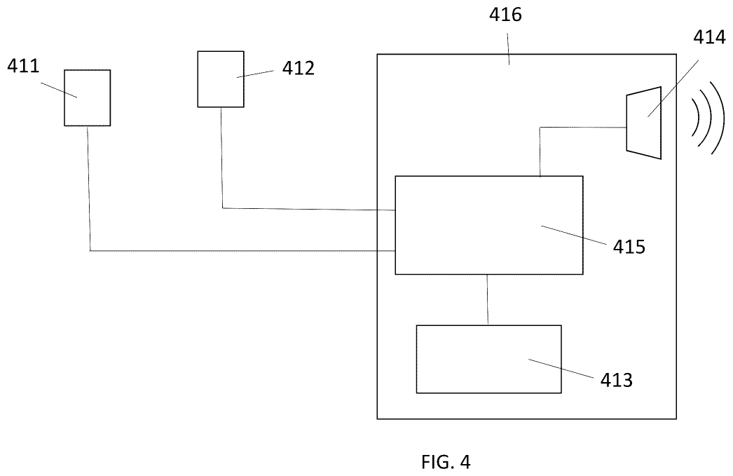

Referring to FIG. 4, first input sensor 411, second input sensor 412 are communicatively coupled to a means for sound generation 416. The means for sound generation 416 comprises power source 413, speaker 414 and microchip 415.

Described herein are articles comprising: a 3-D printed face attached to a panel, wherein the 3-D printed face is 3-D printed using a software-generated rendition of a face of a subject; an input sensor; a means for sound generation; and wherein the means for sound generation is communicatively coupled with the input sensor and wherein the means for sound generation is configured to play an audible identity indicator when the input sensor is activated.

Also described herein are articles comprising: a 3-D cast face attached to a panel, wherein the cast face is cast from a mold that was generated from a software-generated rendition of a face of a subject, wherein the software-generated rendition of the face comprises from a top of the head to underneath a chin and from a first ear to a second ear and encompasses at least one of a forehead, eyes, nose and mouth; an input sensor; a means for sound generation; wherein the means for sound generation is communicatively coupled with the input sensor and is configured to play an audible identity indicator when the input sensor is activated.

### 1. Face

### a. 3-D Printed Face

In one aspect, the disclosed article comprises a 3-D printed face attached to a panel.

In one aspect, the 3-D printed face is 3-D printed using a software-generated rendition of a face of a subject.

In some aspects, the 3-D printed face is attached to the panel with an adhesive. For example, the adhesive may be, but is not limited to, glue, epoxy, gum, paste, cement. In some aspects the 3-D printed face is attached to the panel with a mechanical fastener. For example, mechanical fasteners include, but are not limited to, screws, bolts, rivets, pins, anchors and studs.

In some aspects, the article comprises more than one 3-D printed face.

In some aspects, the article comprises a second 3-D printed face wherein the second 3-D printed face is a software-generated rendition of a face of a second subject.

In some aspects, the article comprises two 3-D printed faces, three 3-D printed faces, four 3-D printed faces, five 3-D printed faces, six 3-D printed faces, seven 3-D printed faces, eight 3-D printed faces, nine 3-D printed faces, ten 3-D printed faces or more than ten 3-D printed faces.

### b. 3-D Cast Face

In one aspect, the disclosed article comprises a 3-D cast face attached to a panel. As detailed herein, the 3-D cast face is cast from a 3-D printed mold that was generated from a software-generated rendition of a face of a subject

In some aspects, the software-generated rendition of the face comprises from a top of the head to underneath a chin and from a first ear to a second ear and encompasses at least one of a forehead, eyes, nose and mouth.

In some aspects, the 3-D cast face is attached to the panel with an adhesive. For example, the adhesive may be, but is not limited to, glue, epoxy, gum, paste, cement. In some aspects the 3-D printed face is attached to the panel with a mechanical fastener. For example, mechanical fasteners include, but are not limited to, screws, bolts, rivets, pins, anchors and studs.

In some aspects, the article comprises a second 3-D cast face wherein the second 3-D cast face is manufactured from a second silicon mold made with a second 3-D printed face using a second software-generated rendition of a face of a second subject.

In some aspects, the article comprises two 3-D cast faces, three 3-D cast faces, four 3-D cast faces, five 3-D cast faces, six 3-D cast faces, seven 3-D cast faces, eight 3-D cast faces, nine 3-D cast faces, ten 3-D cast faces or more than ten 3-D cast faces.

### 2. An Input Sensor

In one aspect, the disclosed article comprises an input sensor.

In some aspects, the input sensor comprises text in braille.

In some aspects, the input sensor is a pressure-sensitive sensor. In some aspects, the input sensor is a touch sensor. In some aspects, the input sensor is a capacitative touch sensor. In some aspects, the input sensor is a push-button switch.

In some aspects, the input sensor has a single output. In some aspects, the input sensor has more than one, in embodiments, two, three, four or more outputs.

In some aspects, the input sensor is underneath the 3-D printed face or the 3-D cast face. In some aspects, the input sensor is below, above, to the right, to the left of, or within the 3-D printed face or the 3-D cast face.

In some aspects, the article comprises a second input sensor.

### 3. Means for Sound Generation

In one aspect, the disclosed articles comprise a means for sound generation. In some aspects, the means for sound generation comprises a player that contains the audio file or audio files. In some embodiments, the means for sound generation is a solid state audio player. For example, the digital audio repeater can be the digital audio repeater manufactured by Signal-Innova or SoundClip or SoundClip-2 by blackbox-av.

In some aspects, the means for sound generation comprises a speaker. In some aspects, the means for sound generation further comprises a Bluetooth transmitter for wireless sound transmission.

As detailed herein, the means for sound generation is communicatively coupled with the input sensor. In some aspects, the means for sound generation is configured to play an audible identity indicator when the input sensor is activated.

In some aspects, the audible identity indicator identifies a name of the subject.

In some aspects, the article comprises a second input sensor wherein the second input sensor is communicatively coupled with the means for sound generation and wherein the means for sound generation is configured to play a second audible identity indicator when the second input sensor is activated.

### C. Methods of Making a 3-Dimensional Portrait of a Subject

### 1. Printing and Casting Methods

In one aspect, disclosed are methods of making a 3-dimensional portrait of a subject comprising: (i) printing a software-generated rendition of a face of the subject using additive manufacturing to make a 3-D printed face, wherein the software-generated rendition of the face is created by a) scanning the face of the subject with a 3-D scanner or b) by a computer program generating a 3-D model using a series of 2D images, and wherein the software rendition of the face comprises from a top of a head to underneath a chin and from a first ear to a second ear and encompasses at least one of a forehead, an eye, a nose or a mouth; (ii) attaching the 3-D printed face to a panel; (iii) attaching an input sensor to the panel next to or within the 3-D printed face; and (iv) attaching a means for sound generation to the input sensor, wherein the means for sound generation is communicatively coupled with the input sensor, and wherein the means for sound generation is configured to play an audible identity indicator when the input sensor is activated.

The software-generated rendition of the face may be generated by scanning a face and/or head using a commercially available scanner and software, such as Keyence 3D Optical Profiler or Revopoint POP 3. Alternatively, the software-generated rendition of the face may be generated by photogrammatry, the making of a 3D model using a series of 2D images. Examples of photogrammatry software include 3D Model Creator by Polycam (poly.cam/tools/photogrammetry) and MagiScan Premium.

In some aspects, the method further comprises (v) printing a software-generated rendition of a face of a second subject using additive manufacturing to make a second 3-D printed face; (vi) attaching the second 3-D printed face to the panel; (vii) attaching a second input sensor to the panel next to or within the second 3-D printed face; wherein the means for sound generation is communicatively coupled with the second input sensor, and wherein the means for sound generation is configured to play a second audible identity indicator when the second input sensor is activated.

### 2. Printing Methods

In one aspect, disclosed are methods of making a 3-dimensional portrait comprising: (i) printing a software-generated rendition of a face of the subject using additive manufacturing to make a 3-D printed face, wherein the software-generated rendition of the face is created by a) scanning the face of the subject with a 3-D scanner or b) by a computer program generating a 3-D model using a series of 2D images, and wherein the software rendition of the face comprises from a top of a head to underneath a chin and from a first ear to a second ear and encompasses at least one of a forehead, an eye, a nose or a mouth; (ii) making a silicon mold with the 3-D printed face; (iii) using the silicon mold to cast a 3-D cast face; (iv) attaching the 3-D cast face to a wooden panel; (v) attaching an input sensor to the panel next to or within the 3-D cast face; and (vi) attaching a means for sound generation to the input sensor, wherein the means for sound generation is communicatively coupled with the input sensor, and wherein the means for sound generation is configured to play an audible identity indicator when the input sensor is activated.

The software-generated rendition of the face may be generated by scanning a face and/or head using a commercially available scanner and software, such as Keyence 3D Optical Profiler or Revopoint POP 3. Alternatively, the software-generated rendition of the face may be generated by photogrammatry, the making of a 3D model using a series of 2D images. Examples of photogrammatry software include 3D Model Creator by Polycam (poly.cam/tools/photogrammetry) and MagiScan Premium.

In some aspects, the methods of making a 3-dimensional portrait further comprise (vii) manufacturing a second 3-D cast face of a second subject; (viii) attaching the second 3-D cast face to the panel; (iv) attaching a second input sensor to the panel next to or within the second 3-D cast face; wherein the means for sound generation is communicatively coupled with the second input sensor, and wherein the means for sound generation is configured to play a second audible identity indicator when the second input sensor is activated.

### 3. Scanning Methods

In one aspect, disclosed are methods of making a 3-dimensional portrait comprising: (i) scanning a head with a scanner to create a software-generated rendition of the head or using a computer program to generate a 3-D model using a series of 2D images; (ii) using software to limit the software-generated rendition of the head to a software-generated rendition of a face, wherein the software-generated rendition of the face comprises from a top of the head to underneath a chin and from a first ear to a second ear and encompasses at least one of a forehead, eyes, nose and mouth; (iii) printing the software-generated rendition of the face using additive manufacturing to make a 3-D printed face; (iv) attaching the 3-D printed face to a wooden panel; (v) attaching an input sensor to the panel next to or within the 3-D printed face; and (vi) attaching a means for sound generation to the input sensor, wherein the means for sound generation is communicatively coupled with the input sensor, and wherein the means for sound generation is configured to play an audible identity indicator when the input sensor is activated.

The software-generated rendition of the face may be generated by scanning a face and/or head using a commercially available scanner and software, such as Keyence 3D Optical Profiler or Revopoint POP 3.

In some aspects, the methods of making a 3-dimensional portrait further comprise (vii) 3-D printing a second software-generated rendition of a face of a second subject using additive manufacturing to make a second 3-D printed face; (viii) attaching the second 3-D printed face to the panel; (ix) attaching a second input sensor to the panel next to or within the second 3-D printed face; wherein the means for sound generation is communicatively coupled with the second input sensor, and wherein the means for sound generation is configured to play a second audible identity indicator when the second input sensor is activated.

### D. Prophetic Example

### 1. Example 1—Making a 3D-Printed Article

Scanning and printing:
1. Seat subject in low set chair without headrest
2. Ensure 3D scanner is plugged in
3. Ensure 3D scanning software (varied softwares can be used depending on the scanner and its quality) is properly reading and displaying scan
4. Starting at the middle of the face move scanner around to the left half of face and head (up to ear) at roughly 6 in away
5. Continuously look at scanning software to ensure proper scanning and lack of gaps
6. Once left side has been finished move back towards the middle of the face, making sure to scan both the top of the head and under the chin
7. Move scanner over the right side of the face, again watching the software to ensure good scan
8. Once the scan is complete, take a picture of the subject
9. Double check scan and make adjustments as necessary to smoothen out face and match what was taken on picture
10. 3D print the face, watch for failures in the printing process
11. Clean print as necessary
12. Using sandpaper, soften the ridges created during the printing process
13. Clean and shine print

### Board Creation:

1. Design is based upon number of subjects, board sizes: 1-2, 3-4, 5-6, 7-8 members of family
2. Using a laser cutter, CNC machine, or hand tools if absolutely necessary, cut out shapes and dimensions of general board, and set general position for faces and name plates.
3. Using volunteers and glue, attach faces and name plates in proper positions
4. Attach power source (AAA batteries) to backside bottom left of board
5. Attach speaker to backside bottom right of board
6. Attach buttons to right of each name plate
7. Run wires from buttons to central chip with mp3s stored
8. Run wires from chip to speaker
9. Cover back and attach hinge (end product would be essentially a thin box with a hinge).

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An article comprising:
(i) a 3-D printed face attached to a panel, wherein the 3-D printed face is 3-D printed using a software-generated rendition of a face of a subject;
(ii) an input sensor;
(iii) a means for sound generation;
wherein the means for sound generation is communicatively coupled with the input sensor and wherein the means for sound generation is configured to play an audible identity indicator when the input sensor is activated.

2. The article of claim 1, wherein the 3-D printed face is attached to the panel with an adhesive or a mechanical fastener.

3. The article of claim 1, wherein
(a) the input sensor comprises text in braille;
(b) the input sensor is a pressure-sensitive sensor, a touch sensor, a capacitative touch sensor or a push-button switch;
(c) the input sensor is under or integrated with the 3-D printed face such that when the 3-D printed face is touched, the input sensor is activated; and/or
(d) the input sensor is below, above, to the right of, to the left of, or within the 3-D printed face.

4. The article of claim 1, wherein the means for sound generation comprises a solid state player.

5. The article of claim 1, wherein the means for sound generation comprises a speaker or a Bluetooth transmitter.

6. The article of claim 1, wherein the audible identity indicator identifies a name of the subject.

7. The article of claim 1, wherein the article comprises a second 3-D printed face and wherein the second 3-D printed face is a software-generated rendition of a face of a second subject.

8. The article of claim 7, further comprising a second input sensor; wherein the second input sensor is communicatively coupled with the means for sound generation and wherein the means for sound generation is configured to play a second audible identity indicator when the second input sensor is activated.

9. An article comprising:
(i) a 3-D cast face attached to a panel, wherein the cast face is cast from a mold that was generated from a software-generated rendition of a face of a subject,
wherein the software-generated rendition of the face comprises from a top of the head to underneath a chin and from a first ear to a second ear and encompasses at least one of a forehead, eyes, nose and mouth;
(ii) an input sensor;
(iii) a means for sound generation;
wherein the means for sound generation is communicatively coupled with the input sensor and is configured to play an audible identity indicator when the input sensor is activated.

10. The article of claim 9, wherein a) the 3-D cast face is attached to the panel with an adhesive or a mechanical fastener.

11. The article of claim 9, wherein
(a) the input sensor comprises text in braille;
(b) the input sensor is a pressure sensitive sensor, a touch sensor, a capacitative touch sensor or a push-button switch;
(c) the input sensor is under or integrated with the 3-D cast face such that when the 3-D cast face is touched, the input sensor is activated; and/or
(d) the input sensor is below, above, to the right of, to the left of, or within the 3-D cast face.

12. The article of claim 9, wherein the article comprises a second 3-D cast face attached to the panel, wherein the second 3-D cast face is manufactured from a second silicon mold made with a second 3-D printed face using a second software-generated rendition of a face of a second subject.

13. The article of claim 9, further comprising a second input sensor; wherein the second input sensor is communicatively coupled with the means for sound generation and wherein the means for sound generation is configured to play a second audible identity indicator when the second input sensor is activated.

14. The article of claim 9, wherein the audible identity indicator identifies a name of the subject.

15. A method of making a 3-dimensional portrait of a subject comprising:
(i) printing a software-generated rendition of a face of the subject using additive manufacturing to make a 3-D printed face,
wherein the software-generated rendition of the face is created by a) scanning the face of the subject with a 3-D scanner or b) by a computer program generating a 3-D model using a series of 2D images, and
wherein the software rendition of the face comprises from a top of a head to underneath a chin and from a first ear to a second ear and encompasses at least one of a forehead, an eye, a nose or a mouth;
(ii) attaching the 3-D printed face to a panel;
(iii) attaching an input sensor to the panel next to or within the 3-D printed face; and
(iv) attaching a means for sound generation to the input sensor, wherein the means for sound generation is communicatively coupled with the input sensor, and wherein the means for sound generation is configured to play an audible identity indicator when the input sensor is activated.

16. The method of claim 15, wherein the step of attaching the 3-D printed face to the panel comprises using an adhesive or a mechanical fastener.

17. The method of claim 15, wherein
(a) the input sensor comprises text in braille;
(b) the input sensor is a pressure sensitive sensor, a touch sensor, a capacitative touch sensor or a push-button switch;
(c) the input sensor is under or integrated with the 3-D printed face such that when the 3-D printed face is touched, the input sensor is activated; and/or
(d) the input sensor is below, above, to the right of, to the left of, or within the 3-D printed face

18. The method of claim 15, wherein the audible identity indicator identifies a name of the subject.

19. The method of claim 15, wherein said method further comprises
(i) printing a software-generated rendition of a face of a second subject using additive manufacturing to make a second 3-D printed face;
(ii) attaching the second 3-D printed face to the panel;
(iii) attaching a second input sensor to the panel next to or within the second 3-D printed face;
wherein the means for sound generation is communicatively coupled with the second input sensor, and wherein the means for sound generation is configured to play a second audible identity indicator when the second input sensor is activated.
